(19) United States
(12) Patent Application Publication
(10) Pub. No.: US 2013/0229082 A1
(43) Pub. Date: Sep. 5, 2013

(54) PERMANENT MAGNET MOTOR

(71) Applicant: JOHNSON ELECTRIC S.A., Murten (CH)

(72) Inventors: Wei ZHANG, Shenzhen (CN); Chui You ZHOU, Hong Kong (CN); Mao Xiong JIANG, Shenzhen (CN); Zeng Hui WU, Shenzhen (CN); Xian Li LU, Shenzhen (CN)

(73) Assignee: Johnson Electric S.A., Murten (CH)

(21) Appl. No.: 13/786,095

(22) Filed: Mar. 5, 2013

(30) Foreign Application Priority Data
Mar. 5, 2012 (CN) 201210055497.8

(51) Int. Cl. H02K 1/27

(52) U.S. Cl. CPC H02K 1/2773
USPC 310/156.15

(57) ABSTRACT

A permanent magnet motor has a stator and a rotor surrounded by the stator. The stator includes a stator core having twelve teeth and coils wound around the teeth. The rotor includes a shaft and a magnet core group secured to the shaft. The magnet core group includes eight rotor core segments and eight ferrite permanent magnets. Each magnet is sandwiched between adjacent rotor core segments and is polarized in the circumferential direction of the rotor. The magnets are alternately magnetized such that adjacent rotor core segments have opposite polarities.

### CROSS REFERENCE TO RELATED APPLICATIONS

This non-provisional patent application claims priority under 35 U.S.C. §119(a) from Patent Application No. 201210055497.8 filed in The People's Republic of China on Mar. 5, 2012.

### FIELD OF THE INVENTION

The present invention relates to permanent magnet motors, and in particular, to a permanent magnet motor applied in an air multiplier.

### BACKGROUND OF THE INVENTION

There are many applications for permanent magnet motors, such as bladeless fans, where there is a desire for smaller, lighter and more powerful motors, so that the end product is lighter or better. What is desired in these motors is a high power density, that is, a higher power output per unit volume occupied by the motor. In order to meet the above requirements, such motors usually employ rare earth permanent magnets. However, as the price of the rare earth material increase, the cost of the motor also increases. In addition, as these motors are often used in house appliances, there is a desire for the motor to be quiet, that is, to generate low levels of mechanical noise. One prior art permanent magnet motor which has been used in a bladeless fan used rare earth magnets in a six pole and nine slot configuration. The noise of this kind of motor is less than satisfactory. Therefore, reducing the cost of the motor while maintaining the performance, and at the same time reducing the noise of the motor have gradually become a concern.

Thus there is a desire for a permanent magnet motor that has low cost, good performance and generates low levels of noise.

### SUMMARY OF THE INVENTION

Accordingly, in one aspect thereof, the present invention provides a permanent magnet motor comprising: a stator comprising an stator core having twelve teeth and coils wound around the teeth; and a rotor surrounded by the stator and comprising a shaft and a magnet core group secured to the shaft, wherein the magnet core group comprises eight rotor core segments and eight ferrite permanent magnets, each magnet being sandwiched between adjacent rotor core segments and polarized in the circumferential direction of the rotor, and adjacent rotor core segments have opposite polarities.

Preferably, each tooth is inclined relative to the axial direction of the motor.

Preferably, a curvature of a radially outer surface of each rotor core segment facing the stator is greater than that of a surface of each tooth facing the rotor.

Preferably, the magnet core group comprises two clamping plates at two axial ends thereof and a number of connecting rods connecting the two clamping plates, and each rotor core segment comprises an axial through hole through which the corresponding connecting rod passes to engage the corresponding rotor core segment.

Preferably, each rotor core segment comprises two lugs extending from two circumferentially opposite sides of a radially outer portion thereof, and one surface of each permanent magnet facing away from the shaft abuts two adjacent lugs.

Preferably, the magnet core group further comprises a sleeve secured to the shaft, each rotor core segment is secured to the sleeve, and the sleeve is made of a material with high magnetic reluctance.

Preferably, the sleeve is octahedron-shaped and comprises eight dovetail grooves at the corners thereof, extending in the axial direction, and a radially inner end portion of each rotor core segment is dovetail shaped and is form locked to the corresponding dovetail groove in the sleeve.

Preferably, the rotor comprises two magnet core groups secured to the shaft, and the two magnet core groups are offset from each other circumferentially.

Preferably, the two adjacent magnet core groups are offset from each other by 7.5 degrees.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 shows a permanent magnet motor according to the preferred embodiment of the present invention;

FIG. 2 shows a stator of the permanent magnet motor of FIG. 1, without coils;

FIG. 3 is a cross sectional view of a rotor of the permanent magnet motor of FIG. 1;

FIG. 4 is a partially exploded view of the rotor of FIG. 3;

FIG. 5 shows a rotor of a permanent magnet motor according to another embodiment of the present invention; and

FIG. 6 shows a stator of a permanent magnet motor according to yet another embodiment of the present invention.

### DETAILED DESCRIPTION OF THE PREFERRED EMBODIMENTS

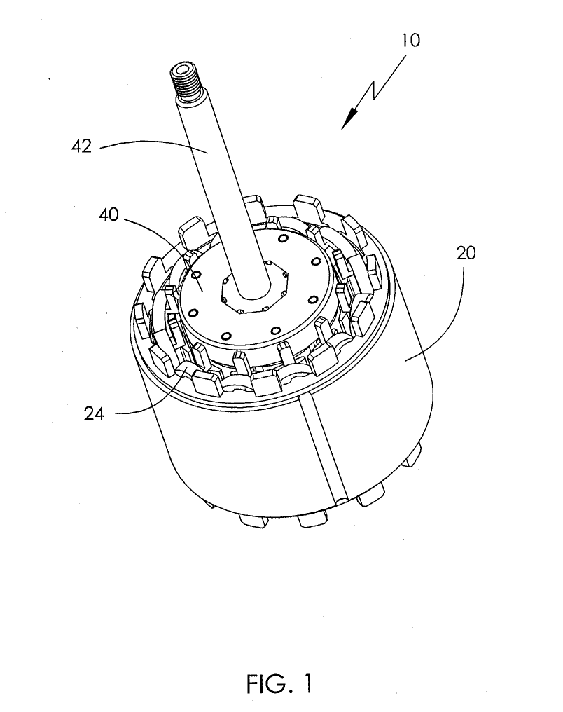

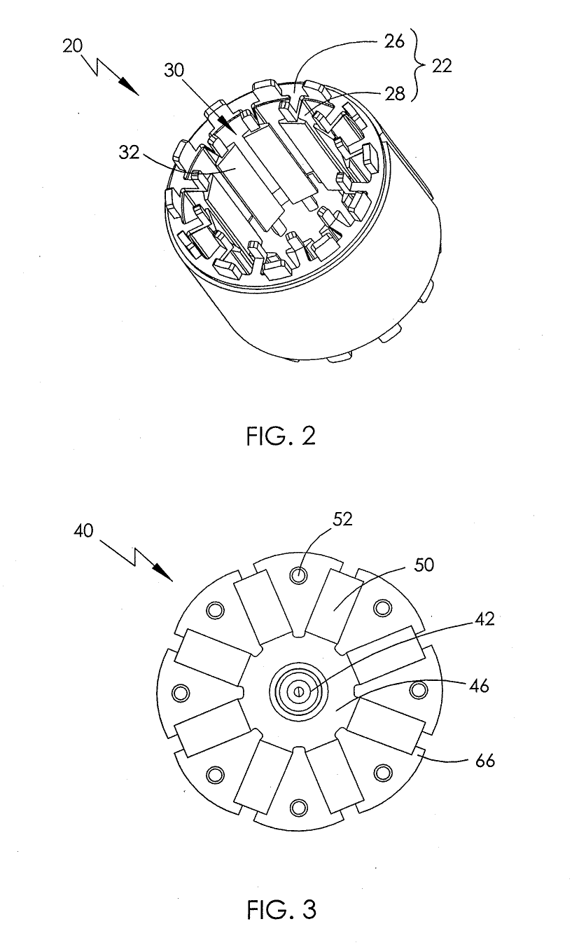

FIG. 1 illustrates a permanent magnet motor 10 according to a first preferred embodiment of the present invention. The motor is shown without end caps to reveal the rotor and stator arrangement. The motor includes a stator 20 and a rotor 40 received in the stator 20. Coils 24 forming the stator winding are shown wound about teeth of the stator. The stator is shown more clearly in FIG. 2, although the coils have been omitted to show the construction of the stator core more clearly.

The stator 20 includes a stator core 22 comprising an annular yoke 26 and twelve teeth 28 extending radially inwards from an inner surface of the yoke 26. That is to say, there are twelve slots 30 formed by the teeth 28. Each tooth 28 also extends in the axial direction of the stator 20 and includes a surface 32 that faces the rotor 40, that is faces towards the axis (not shown) of the motor. The surface 32 of each tooth 28 is curved in the circumferential direction of the stator 20. Each coil 24 (FIG. 1) is wound around a corresponding tooth 28.

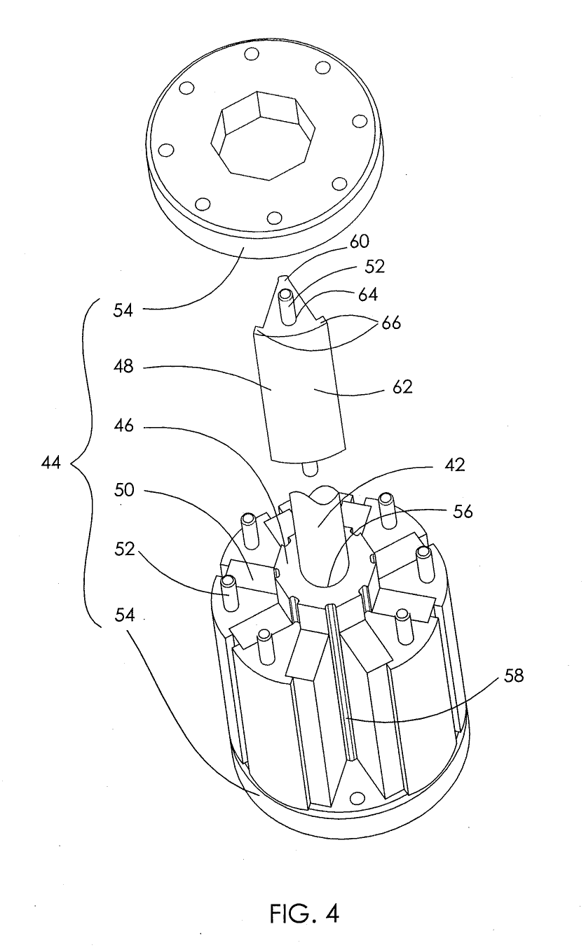

Referring to FIGS. 3 and 4, the rotor 40 includes a shaft 42 and a magnet core group 44 secured to the shaft 42. The magnet core group 44 includes a sleeve 46, eight rotor core segments 48, eight permanent magnets 50 made of ferrite magnet, eight connecting rods 52, and two clamping plates 54 located at the axial ends of the magnet core group.

The sleeve 46 is octahedron-shaped and is made of high magnetic reluctance material such as plastics or aluminum. The sleeve 46 defines a shaft hole 56 at a middle portion thereof for fixedly receiving the shaft 42 and eight dovetail grooves 58 at the corners thereof. The shaft hole 56 and the dovetail grooves 58 extend in the axial direction of the sleeve 46. The sleeve 46 can be over molded or interference fit on the shaft 42.

Each rotor core segment 48 is substantially fan-shaped, including a radially inner portion 60 and a radially outer portion. The radially inner portion 60 is narrower than the radially outer portion. The radially inner portion 60 is dovetail-shaped and is received in a corresponding dovetail groove 58 of the sleeve 46, thereby securing the rotor core segment 48 to the sleeve 46. A surface 62 of the radially outer portion that faces away from the inner portion 60 is curved in the circumferential direction of the rotor 40 and the curvature thereof is greater than that of the surface 32 of the tooth 28. That is, the radius of curvature of the radially outer surface of the rotor core segments is less than the nominal radius of the rotor, measured at a circumferential center of the outer surface of a rotor core segment. This feature reduces the cogging torque and lowers the audible or mechanical noise of the rotor 40. Each rotor core segment 48 further defines an axial through hole 64 at the middle portion thereof. Two lugs 66 extend respectively from opposite sides of the radial outer portion in the circumference direction thereof. Each rotor core segment 48 is made of a magnetically conductive material such as iron or steel and is preferably made by stacking together a plurality of stamped laminations of electrical steel sheet.

Each permanent magnet 50 is a rectangular prism. Each permanent magnet 50 is secured between two adjacent rotor core segments 48, abutting against two adjacent lugs 66 and the sleeve 46 and sandwiched between the two clamping plates 54. Each permanent magnet 50 contacts the side surfaces of corresponding rotor core segments 48. Each permanent magnet 50 is polarized along a direction parallel to the short side thereof, that is, substantially in the circumferential direction of the rotor 40. At the same time, adjacent permanent magnets 50 have opposite polarities.

Each connecting rod 52 passes through the through hole 64 in corresponding rotor core segment 48 to engage with the rotor core segment 48. The clamping plates 54 are respectively arranged at the axial ends of each magnet 50 and are respectively connected to the connecting rods 52 for example by a tight fit or glue. It should be understood that the connecting rods 52 and the clamping plates 54 can be integrally formed, for example by injection molding.

As such, the magnetic flux of adjacent permanent magnets 50 are concentrated in the rotor core segment 48 there between, thereby the eight rotor core segments 48 form eight magnetic poles by magnet flux concentration. Since the sleeve 46 is made of high magnetic reluctance material, the flux between two adjacent permanent magnets 50 is prevented from passing through the sleeve 46, which reduces the magnetic flux leakage. In this way, the rotor has dense magnet flux and low cost, as ferrite magnet is cheaper than rare earth magnets such as NdFeB magnet. Also, the motor has eight poles and twelve slots. Under such an arrangement, the motor of the first preferred embodiment of the present invention concentrates the magnetic flux effectively so as to improve the power density and efficiency of the motor.

Additionally, during testing, it was found that the noise generated by the permanent magnet motor 10 having eight poles and twelve slots described above is about 30 Db, which is significantly less than the noise of 49 Db generated by a permanent magnet motor of the same structure but having six poles and nine slots or the noise of 55 Db generated by a permanent magnet motor of the same structure but having eight poles and nine slots. Therefore, the permanent magnet motor 10 of the first preferred embodiment can meet the requirements of low noise, high power density, and high efficiency.

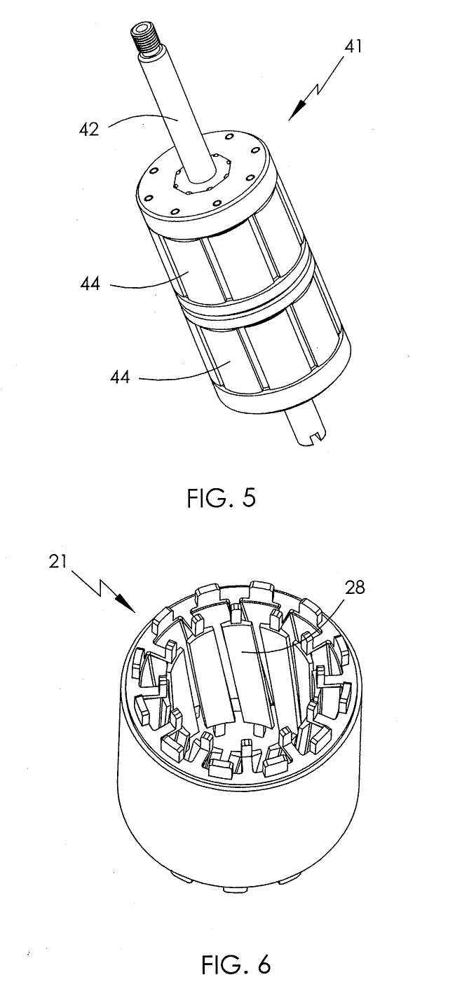

In a second preferred embodiment based on the first embodiment above, two magnet core groups 204 can be employed by the rotor 41, as shown in FIG. 5, to increase the output power of the motor. The two magnet core groups 44 may be offset from each other to reduce the cogging torque. In this embodiment, the two magnet core groups 44 are offset from each other by 7.5 degrees. During testing, it was found that the cogging torque of a motor made according to this second preferred embodiment was reduced to one fifth of that of a motor made according to the first embodiment.

In a third embodiment based on the first embodiment above, the teeth 28 of the stator 21 are inclined relative to the shaft, as shown in FIG. 6, to reduce the cogging torque. That is, the teeth are skewed by slightly rotating one or more laminations of the stator core as they are being stacked together.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

1. A permanent magnet motor, comprising:
a stator comprising an stator core having twelve teeth and coils wound around the teeth; and
a rotor surrounded by the stator and comprising a shaft and a magnet core group secured to the shaft,
wherein the magnet core group comprises eight rotor core segments and eight ferrite permanent magnets, each magnet being sandwiched between adjacent rotor core segments and polarized in the circumferential direction of the rotor, and adjacent rotor core segments have opposite polarities.

2. The motor of claim 1, wherein each tooth is skewed relative to the axial direction of the motor.

3. The motor of claim 1, wherein a curvature of a radially outer surface of each rotor core segment facing the stator is greater than that of a surface of each tooth facing the rotor.

4. The motor of claim 1, wherein the magnet core group comprises two clamping plates at two axial ends thereof and a number of connecting rods connecting the two clamping plates, each rotor core segment comprises an axial through hole through which the corresponding connecting rod passes to engage the corresponding rotor core segment.

5. The motor of claim 1, wherein each rotor core segment comprises two lugs extending from two circumferentially opposite sides of a radially outer portion thereof, and one surface of each permanent magnet facing away from the shaft abuts two adjacent lugs.

6. The motor of claim 1, wherein the magnet core group further comprises a sleeve secured to the shaft, each rotor core segment is secured to the sleeve, and the sleeve is made of a material with high magnetic reluctance.

7. The motor of claim 6, wherein the sleeve is octahedron-shaped and comprises eight dovetail grooves at the corners thereof, extending in the axial direction, and a radially inner end portion of each rotor core segment is dovetail shaped and is form locked to the corresponding dovetail groove in the sleeve.

8. The motor of claim 1, wherein the rotor comprises two magnet core groups secured to the shaft, and the two magnet core groups are offset from each other circumferentially.

9. The motor of claim 8, wherein the two adjacent magnet core groups are offset from each other by 7.5 degrees.
